(19) United States
(12) Patent Application Publication
(10) Pub. No.: US 2008/0300020 A1
(43) Pub. Date: Dec. 4, 2008

(54) WIRELESS COMMUNICATION SYSTEM, SIM CARD, MOBILE COMMUNICATION TERMINAL, AND DATA GUARANTEEING METHOD

(75) Inventors: Hirotaka Nishizawa, Tokyo (JP); Hideo Koike, Tokyo (JP); Hironori Iwasaki, Tokyo (JP); Junichiro Osako, Tokyo (JP); Minoru Shinohara, Tokyo (JP); Tamaki Wada, Tokyo (JP)

Correspondence Address: MILES & STOCKBRIDGE PC, 1751 PINNACLE DRIVE, SUITE 500, MCLEAN, VA, 22102-3833, US

(73) Assignee: Renesas Technology Corp.

(21) Appl. No.: 12/116,956

(22) Filed: May 8, 2008

(30) Foreign Application Priority Data
Jun. 1, 2007 (JP) 2007-146648

(51) Int. Cl. H04M 1/00

(52) U.S. Cl. 455/558

(57) ABSTRACT

The loss of data stored in a secure memory card, such as a SIM card, due to the physical destruction thereof is prevented. A host unit performs card authentication of a memory card, and transmits update data for the memory card by security communication to update data when the result of the authentication is OK. Then, the host unit outputs a request for mirror-updating the card data to a base station server. When an access is permitted, the card data is transmitted to the base station server via the host unit to mirror-update the card data. When the mirror-updating of the card data is completed, the base station server returns a completion confirmation to the host unit, so that a data backup process is completed. By thus causing the base station server to mirror-update the data in the memory card, the loss of the stored data is prevented.

### CROSS-REFERENCE TO RELATED APPLICATIONS

The disclosure of Japanese Patent Application No. 2007-146648 filed on Jun. 1, 2007 including the specification, drawings and abstract is incorporated herein by reference in its entirety.

### BACKGROUND OF THE INVENTION

The present invention relates to a technology for backing up data in a memory card and, more particularly, to a technology which is effective in guaranteeing data in a SIM (Subscriber Identity Module) card or the like.

In recent years, as mobile phones and mobile equipment have been increasingly reduced in size and increased in density, removable memory cards mounted thereon have also been increasingly reduced in size and thickness and increased in density.

As one of memory cards of this type, a SIM card, e.g., is widely used for a mobile phone. In the SIM card, various data including a unique number referred to as IMSI (International Mobile Subscriber Identity), a mobile phone number, and the like is registered.

A mobile phone is made usable by inserting a SIM card into the slot of the mobile phone. In addition, the insertion of the SIM card into another mobile phone not only makes the mobile phone of another model usable but also allows a plurality of phone numbers to be used selectively in the single mobile phone.

### SUMMARY OF THE INVENTION

However, the present inventors have found that a technology for data storage using a SIM card as mentioned above has the following problems.

The SIM card has important information registered therein, but such provisions as increasing the physical strength thereof have not been made. When bending or distortion resulting from a large external force is applied to the SIM card, the SIM card may be destroyed.

When the SIM card is destroyed, the destruction can be compensated for by the replacement of the SIM card with a new one or the like. However, all the data stored in the SIM card is lost, which leads to the problem of reduced convenience of the user.

An object of the present invention is to provide a technology which can prevent the loss of data stored in a secure memory card, such as a SIM card, resulting from the physical destruction thereof.

The above and other objects and novel features of the present invention will become apparent from the description of the present specification and the accompanying drawings.

As shown below, a brief description will be given to the outline of representative aspects of the invention disclosed in the present application.

In one of the aspects, the present invention comprises: a mobile communication terminal comprising a SIM card in which data including data for determining whether or not wireless communication is usable is stored, an RF communication unit for performing high-frequency power amplification to output a high-frequency signal for performing the wireless communication as well as processing of a signal received by the wireless communication, and a host unit for managing control of the SIM card and the RF communication unit; a plurality of base stations each for receiving an electric wave from the mobile terminal or transmitting the electric wave to the mobile communication terminal, and securing a wireless communication line between itself and the mobile communication terminal with which the base station is in communication; a wireless network control unit for intensifying the electric waves transmitted/received by the base stations to perform integrated control; and a base station server for executing mirror-updating and restoration of the data stored in the SIM card in response to a request from the mobile communication terminal, wherein the base station server has a data storage unit to which the data stored in the individual SIM card is mirror-updated, and mirror-updates the data in the SIM card to the data storage unit when data is newly stored in the SIM card or the data in the SIM card is updated.

In the present invention, the host unit issues, when data is stored in the SIM card, an update request for requesting mirror-updating of the data to the base station server, and transmits the data to be mirror-updated to the base station server, and the base station server mirror-updates the data transmitted from the host unit to the data storage unit when there is the request from the host unit.

In the present invention, the host unit determines that a restoration process for the memory card is necessary when a new card is attached, issues a restoration request for requesting restoration of the data in the memory card that has been used hitherto to the base station server, and stores the mirror-updated data transmitted from the base station server in the new memory card, and the base station server transmits the mirror-updated data of the corresponding memory card stored in the data storage unit to the host unit when there is the request from the host unit.

In another aspect, the present invention is a SIM card comprising: a memory card comprising a nonvolatile semiconductor memory for storing data and a controller for controlling an operation of the nonvolatile semiconductor memory; and a SIM card adapter in which a secure unit for performing secure communication is provided and to which the memory card is attached, wherein the controller comprises an ID control storage unit which is coupled to each of an external power supply terminal supplied with an external power supply voltage and a read interface terminal used when an ID number is read from an outside and which individually operates independently of the controller with a supply of the power supply voltage via the external power supply terminal when the controller becomes inoperative to allow the ID number of the memory card to be read via the read interface terminal.

A brief description will be also given to the outline of the other aspects of the invention of the present application.

In one of the other aspects, the present invention is a method of guaranteeing data using a wireless communication system comprising: a mobile communication terminal including a SIM card in which data including data for determining whether or not wireless communication is usable is stored, an RF communication unit for performing high-frequency power amplification to output a high-frequency signal for performing the wireless communication as well as processing of a signal received by the wireless communication, and a host unit for controlling the SIM card and the RF communication unit; a plurality of base stations each for emitting an electric wave from the mobile communication terminal or transmitting the electric wave to the mobile communication terminal, and securing a wireless communication line between itself and the mobile communication terminal with which the base station is in communication; a wireless network control unit for intensifying the electric waves transmitted/received by the base stations to perform integrated control; and a base station server for executing mirror-updating and restoration of the data stored in the SIM card in response to a request from the mobile communication terminal, the method comprising the steps of: causing the host unit to perform wireless communication with the base station server when updating of the data in the SIM card is completed, and issue the request for the mirror-updating of the update data stored in the SIM card; and causing the base station server to mirror-update, to the data storage unit, the data stored in the SIM card and transmitted from the host unit in response to the request from the host unit, and back up the data stored in the SIM card.

The present invention further comprises the steps of: causing the host unit to perform card authentication when a memory card to be attached to the SIM card is attached, determine that a restoration process for the memory card is necessary when a result of the card authentication of the memory card is discrepant, and issue a request for transmission of the backed-up data to the base station server; causing the base station server to transmit to-be-restored data backed up in the data storage unit in response to the request; and causing the host unit to write, in the memory card, the to-be-restored data transmitted from the base station server.

The following is a brief description of effects achievable by the representative aspects of the invention disclosed in the present application.

(1) Even when the SIM card is destroyed by physical destruction or the like, the loss of the data stored in the SIM card can be prevented.

(2) Because a communication line path in data backup or restoration can be selected arbitrarily, a data communication speed and communication quality can be improved, while performance can be enhanced.

(3) An access limit to the SIM card can be set immediately using another communication terminal so that data protection for the SIM card can be performed more reliably.

(4) The effects (1) to (3) mentioned above allow a significant improvement in the reliability of a wireless communication system constructed using the SIM card.

### BRIEF DESCRIPTION OF THE DRAWINGS

FIG. 1 is an illustrative view showing an example of a structure of a wireless communication system according to a first embodiment of the present invention;

FIG. 2 is a block diagram showing an example of respective structures of a memory card provided in a SIM card and a SIM card adapter in the wireless communication system of FIG. 1;

FIG. 3 is a flow chart showing an example of a data backup process in the wireless communication system of FIG. 1;

FIG. 4 is an illustrative view showing data communication paths in the wireless communication system in the data backup process of FIG. 3;

FIG. 5 is a flow chart showing a data restoration process in the wireless communication system of FIG. 1;

FIG. 6 is an illustrative view showing data communication paths in the wireless communication system in the restoration process of FIG. 5;

FIG. 7 is an illustrative view showing an example when new data overwritten in a memory card is stored in a base station server in the wireless communication system of FIG. 1;

FIG. 8 is an illustrative view showing an example of file history management at the base station server in the wireless communication system of FIG. 1;

FIG. 9 is an illustrative view showing an example of a structure in a wireless communication system according to a second embodiment of the present invention;

FIG. 10 is a flow chart showing an example of a switching process among communication line paths performed by a mobile phone provided in the wireless communication system of FIG. 9;

FIG. 11 is a flow chart showing an example of a detailed process in Step S302 of FIG. 10;

FIG. 12 is a flow chart showing another example of the detailed process in Step S302 of FIG. 10;

FIG. 13 is an illustrative view showing data communication paths in the wireless communication system of FIG. 9;

FIG. 14 is an illustrative view showing an example of data backup in the wireless communication system of FIG. 9;

FIG. 15 is an illustrative view showing an example of file history management at a base station server in the wireless communication system of FIG. 9;

FIG. 16 is a flow chart showing an example of a process when an access limit to a memory card is set according to a third embodiment of the present invention;

FIG. 17 is an illustrative view showing an example of a chip layout of the memory card according to the third embodiment; and

FIG. 18 is a block diagram showing an example of a structure of the controller of FIG. 17.

### DETAILED DESCRIPTION OF THE PREFERRED EMBODIMENTS

Referring to the drawings, the embodiments of the present invention will be described hereinbelow in detail. Throughout all the drawings for illustrating the embodiments, the same members are provided with the same reference numerals in principle and a repeated description thereof will be omitted.

### Embodiment 1

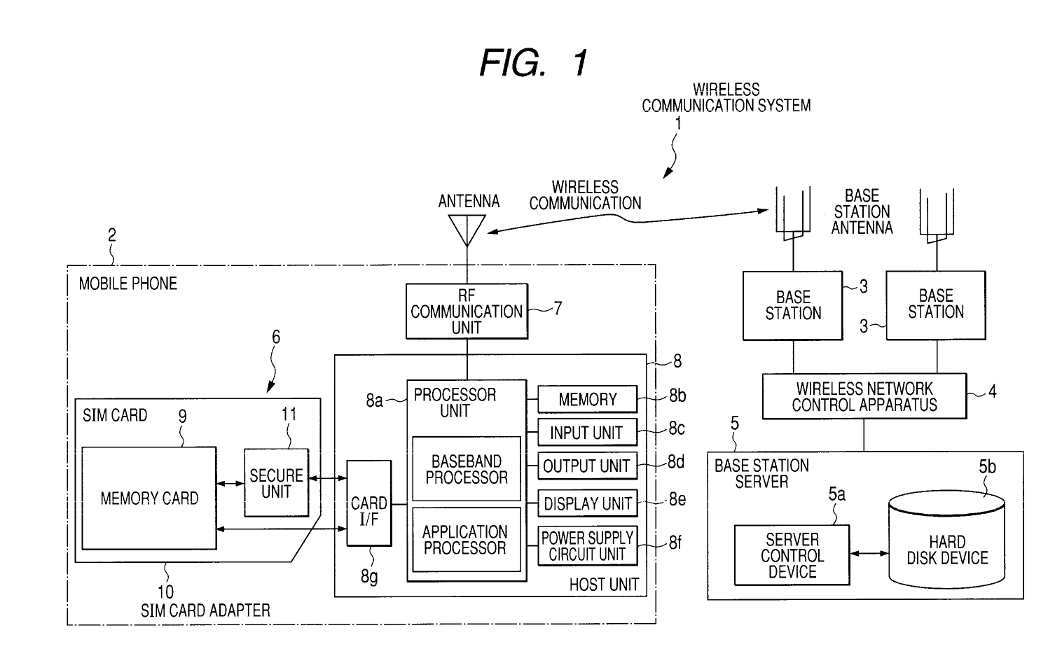

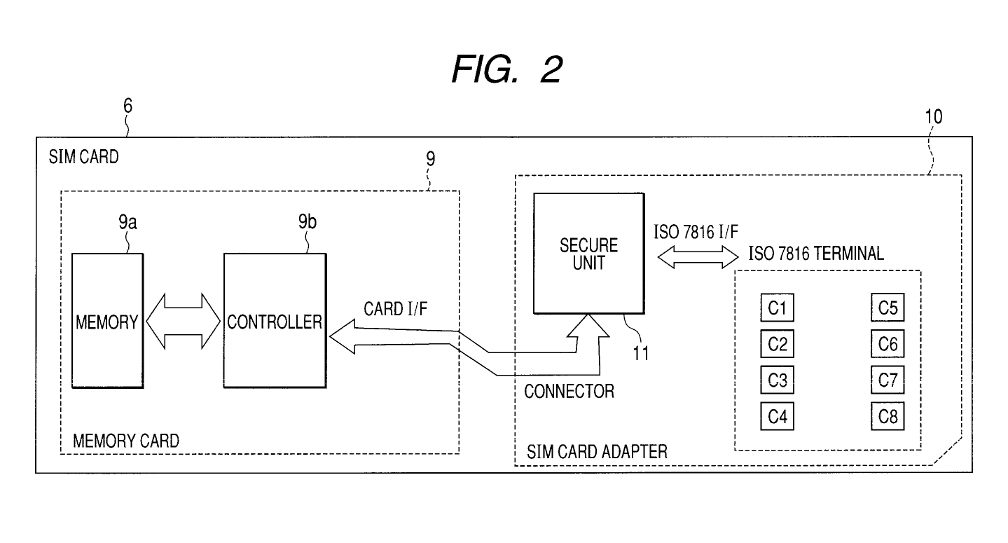

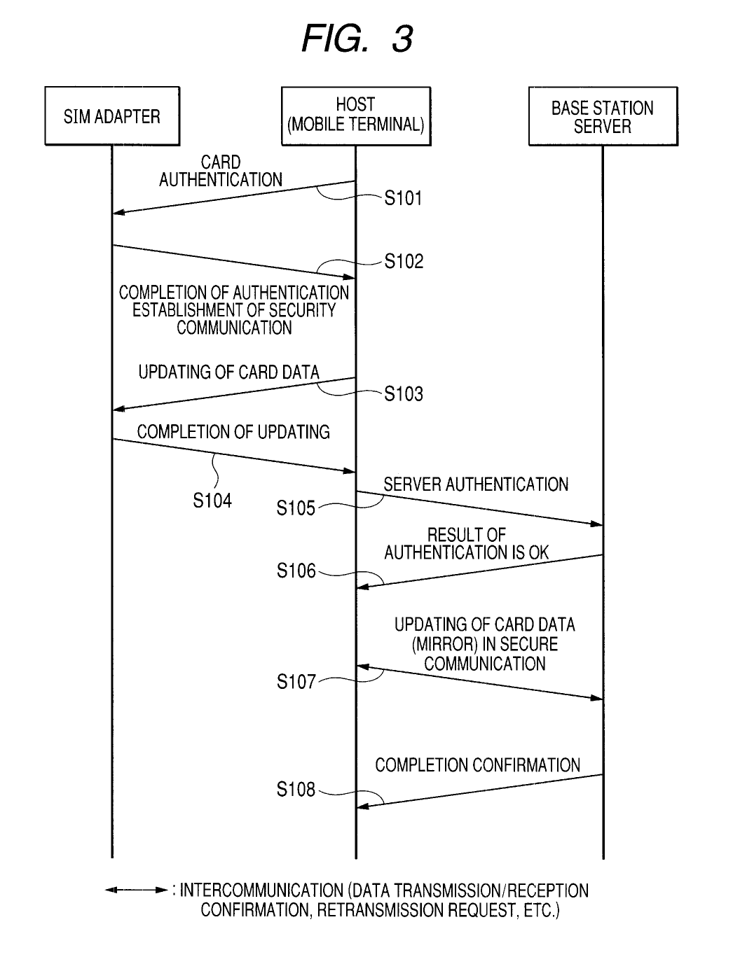

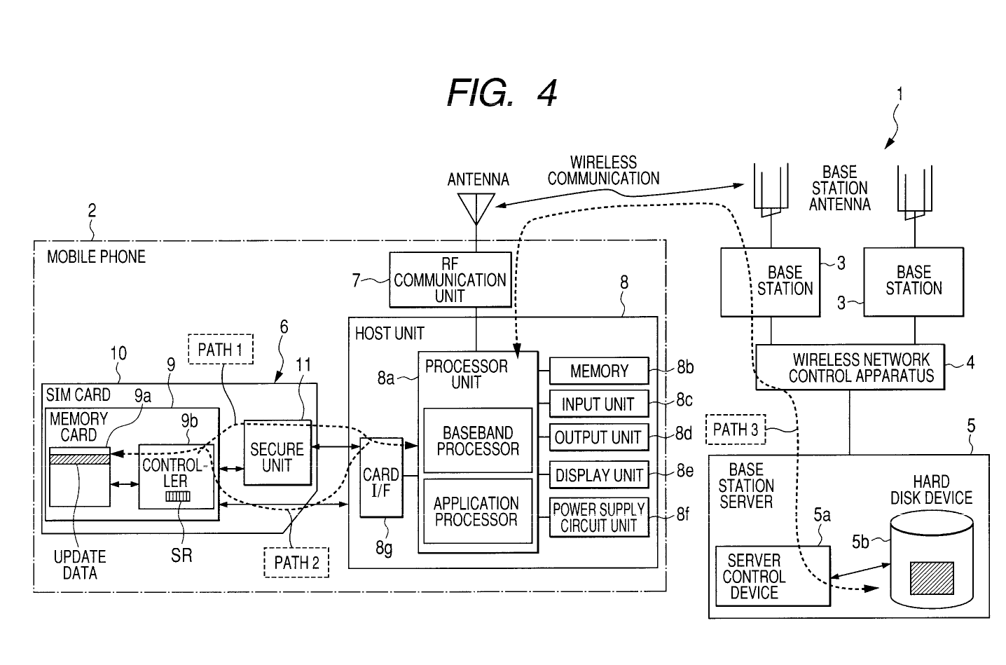

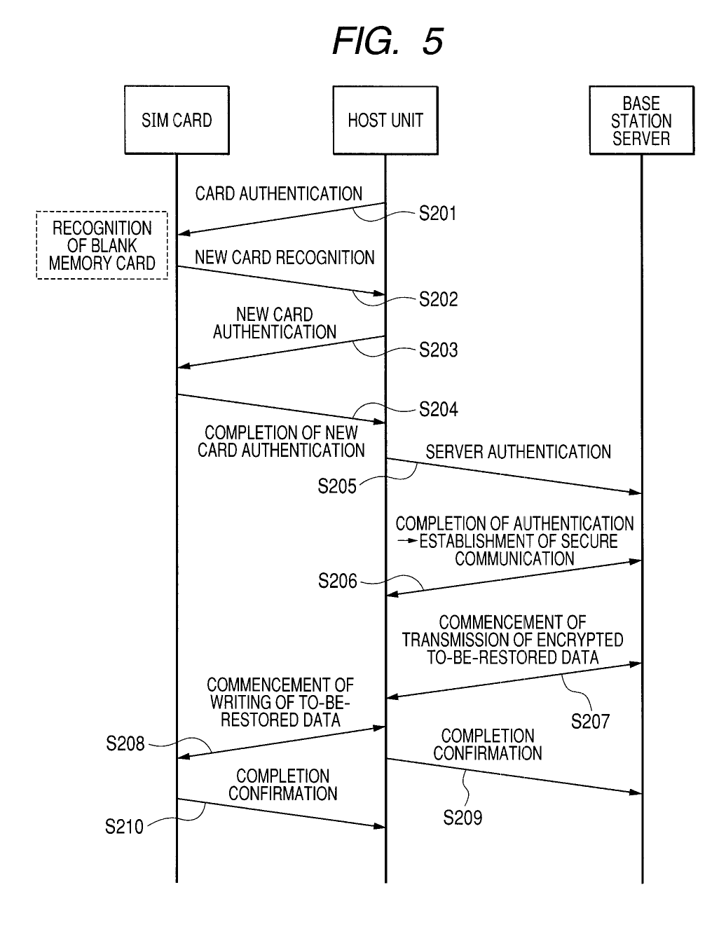

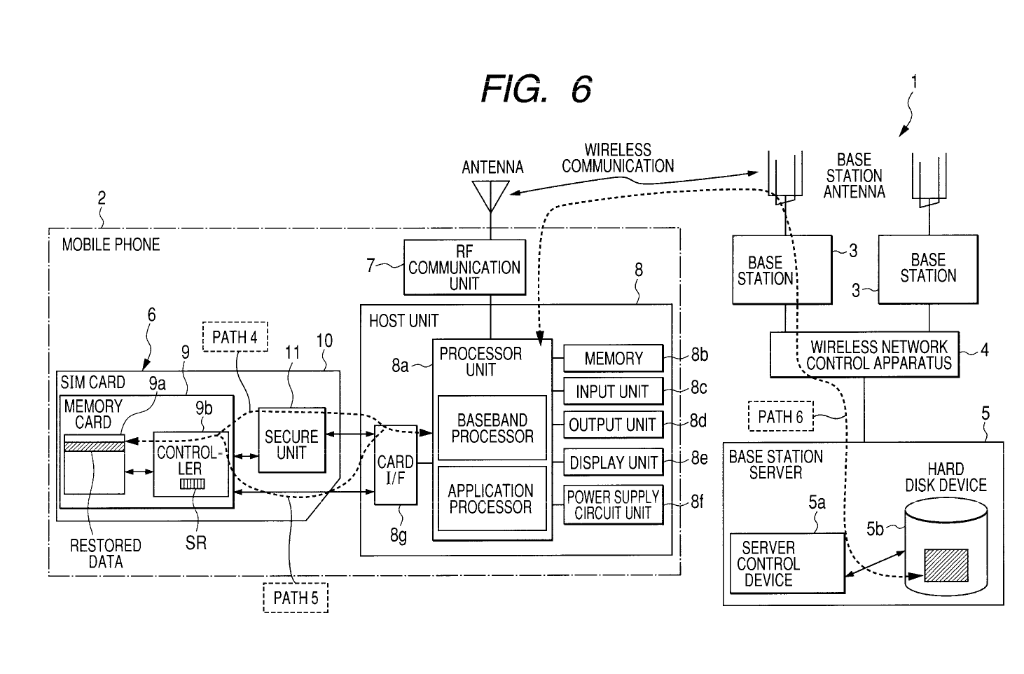

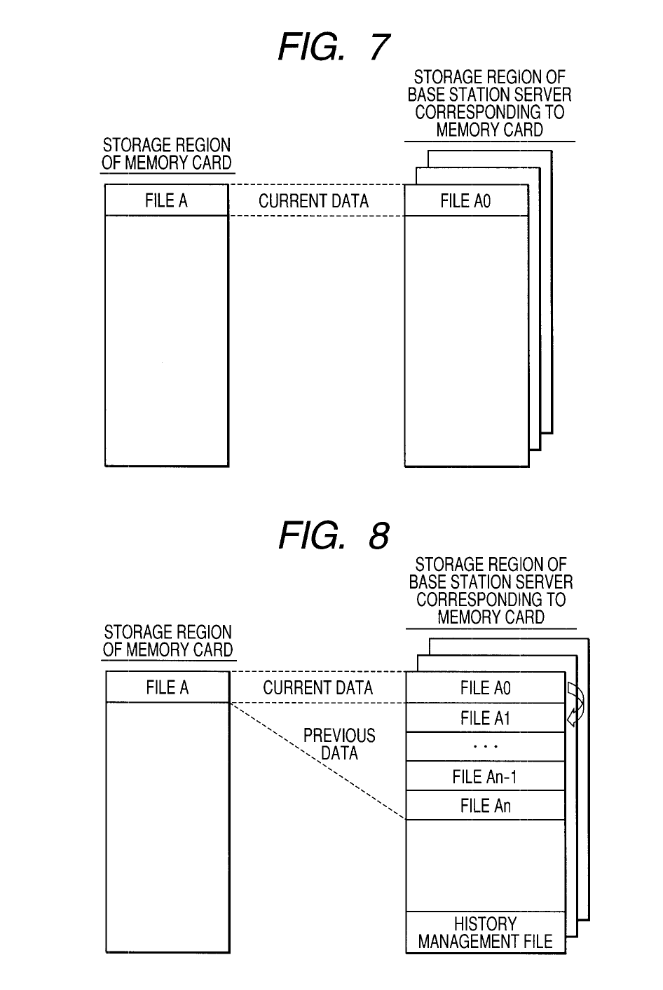

FIG. 1 is an illustrative view showing an example of a structure of a wireless communication system according to the first embodiment of the present invention. FIG. 2 is a block diagram showing an example of respective structures of a memory card provided in a SIM card and a SIM card adapter in the wireless communication system of FIG. 1. FIG. 3 is a flow chart showing an example of a data backup process in the wireless communication system of FIG. 1. FIG. 4 is an illustrative view showing data communication paths in the wireless communication system in the data backup process of FIG. 3. FIG. 5 is a flow chart showing a data restoration process in the wireless communication system of FIG. 1. FIG. 6 is an illustrative view showing data communication paths in the wireless communication system in the restoration process of FIG. 5. FIG. 7 is an illustrative view showing an example when new data overwritten in a memory card is stored in a base station server in the wireless communication system of FIG. 1. FIG. 8 is an illustrative view showing an example of file history management at the base station server in the wireless communication system of FIG. 1.

In the present first embodiment, a wireless communication system 1 comprises a mobile phone 2, base stations 3, a wireless network control apparatus 4, and a base station server 5, as shown in FIG. 1.

The mobile phone 2 is a mobile communication terminal and comprises a SIM card 6, an RF communication unit 7, and a host unit 8. The SIM card 6 is used when the mobile phone is used and has information for recognizing individual mobile phone numbers and the like which is registered therein.

The SIM card 6 comprises a removable-type memory card 9 and a SIM card adapter 10. In the memory card 9, various data is stored, including registered information such as an IMSI number and the mobile phone numbers mentioned above, phone directory data, multimedia contents such as music data, and the like.

The SIM card adapter 10 is provided with a secure unit 11 comprising a secure IC (Integral Circuit) for performing secure communication. The memory card 9 is attached via a memory card connector provided in the SIM card adapter 10.

Although an example is shown in which the SIM card 6 comprises the removable-type memory card 9 and the SIM card adapter 10, the SIM card 6 may also comprise the memory card and the secure IC integrated therein.

The RF communication unit 7 performs high-frequency power amplification to output a high-frequency signal for performing wireless communication via an antenna, signal processing for sending a signal received from the antenna to the host unit by wireless communication, and the like. The host unit 8 manages all control operations in the mobile phone 2. The host unit 8 comprises a processor unit 8a, a memory 8b, an input unit 8c, an output unit 8d, a display unit 8e, a power supply circuit unit 8f, and a memory card interface (I/F) 8g.

The processor unit 8a includes, e.g., a baseband processor and an application processor. The baseband processor executes a real-time OS and a baseband protocol stack. The application processor manages the control of an application.

In the memory 8b, data used for the processor unit 8a and the like are stored. The input unit 8c includes, e.g., a ten-key input unit and the like and receives various information such as phone numbers. The output unit 8d includes a speaker, an earphone jack, and the like. The display unit 8e includes, e.g., a liquid crystal display and displays various information, an image, and the like.

The power supply circuit unit 8f generates an internal power supply voltage to be supplied to the processor unit 8a and the like. The card interface 8g is an interface in performing communication with the SIM card 6. In performing communication with the secure unit 11, the card interface 8g uses, e.g., a communication protocol such as an ISO 7816 interface. In performing communication with the secure unit 11, e.g., in performing direct communication with the memory card 9 without interposition of the secure unit 1 therebetween, the card interface 8g uses a communication protocol such as a USB interface or a memory card interface.

Each of the base stations 3 is provided in an arbitrary area on a one-to-one basis to transmit or receive an electric wave emitted from the mobile phone 2 to secure a communication line between itself and the mobile phone 2 with which it is in communication. The wireless network control apparatus 4 intensifies electric waves transmitted/received by the base stations 3 and performs integration with the base station server 5.

The base station server 5 includes a server control device 5a and a hard disk device 5b. The server control device 5a performs the control of the hard disk device 5b. The hard disk device 5b serving as a data storage unit is a memory device for performing reading and writing of various information under the control of the server control device 5a

The base station server 5 responds to a request from the mobile phone 2 and executes mirror-updating of data stored in the memory card 9, restoration of the data, and the like.

When the data in the memory card 9 is updated (e.g., an addition of data to an address data, a change of data therein, a deletion of data therefrom, or the like), the update data is sent via the secure unit 11 to the base station 3 by wireless communication through the RF communication unit 7. From the base station 3, data of the same content as the card data is mirror-updated to the base station server 5 via the wireless network control device 4.

The memory card 9 is provided with an authentication system as a trusted device (device guaranteed by device authentication) for allowing individual identification or with the ID (authentication number) of a secure card. To the base station server 5, a card data region corresponding to the device authentication of the memory card 9 is allocated.

By thus completely interfacing with the base station server 5, it becomes possible to completely back up and restore the data in the memory card 9 and ensure significantly high reliability to the memory card 9.

Compared with the registered information such as the IMSI number and the mobile phone number, user data stored individually by a user such as phone directory data stored for each mobile phone user on a one-by-one basis and multimedia contents including music data and the like may be large in amount.

The backing up and restoration of these data items increases safe data retention and is extremely useful to the mobile phone user.

FIG. 2 is a block diagram showing an example of respective structures of the memory card 9 provided in the SIM card 6 and the SIM card adapter 10.

As shown in the drawing, the memory card 9 comprises the memory 9a including a nonvolatile semiconductor memory exemplified by a flash memory and the controller 9b for controlling the operation of the memory 9a.

The SIM card adapter 10 comprises the memory-card connector for the attachment of the memory card 9, the secure unit 11, and SIM-card external terminals C1 to C8. These SIM-card external terminals C1 to C8 are external terminals standardized according to the ISO 7816. According to the ISO 7816, the USB terminals (C4 and C8) are allocated besides the standard IC-card terminals (C1 to C5 and C7).

When the SIM card adapter 10 communicates with the host unit 8, the communication is performed via these SIM-card external terminals C1 to C8. The secure unit 11 performs communication with the memory card 9 via the memory-card connector.

In this case, for the communication between the secure unit 11 and the memory card 9, an interface such as Memory Stick (registered trademark), SD (Secure Digital) card (registered trademark), or MMC (MultiMedia Card) (registered trademark) is used.

Next, a description will be given to a data backup process in the wireless communication system 1 in the present embodiment with reference to the flowchart of FIG. 3.

FIG. 3 shows the process when mirror data in the base station server 5 is updated in synchronization with the updating of data in the memory card 9.

First, the host unit 8 performs card authentication of the memory card 9 (Step S101). When the result of the card authentication is OK, the subsequent communication will be brought into an encrypted communication state (Step S102). When the card authentication cannot be accomplished in the process of Step S101, the process is interrupted.

Subsequently, the host unit 8 transmits update data (for data addition, data change, or data deletion) for the memory card 9 by security communication (Step S103) to update the data in the memory card 9.

When the updating of the data is completed (Step S104), the host unit 8 outputs a request for mirror-updating the data in the memory card 9 to the base station server 5. The host unit 8 performs server authentication (Step S105) and requests an access permission to the card data region in the base station server 5 allocated to the memory card 9 mounted on the SIM card 6 when the authentication is successful (Step S106). On the other hand, when the server authentication is not accomplished in the process of Step S105, the process is interrupted.

When the access permission is given, the card data is transmitted to the base station server 5 via the host unit 8 where the mirror-updating of the card data is performed (Step S107). Thereafter, when the mirror-updating of the card data is ended, the base station server 5 returns a completion confirmation to the host unit 8 (Step S108), whereby the data backup process is completed.

For the communication between the host unit 8 and the base station server 5, a communication procedure based on secure communication such as, e.g., the SSL (Secure Socket Layer) is used to allow the prevention of intercepted communication. In the communication between the host unit 8 and the base station server 5, data is divided into individual packets.

In the event of the occurrence of a communication error between the host unit 8 and the base station server 5, the process of updating the card data in the base station server 5 may also be elongated till communication becomes possible. At this time, it is also possible to store the temporarily stored data of the update data in the memory region provided in the host unit 8 and provide a guarantee against the physical breakage of the card during a period till communication recovers.

FIG. 4 is an illustrative view showing data communication paths in the wireless communication system 1 in the data backup process of FIG. 3.

First, a description will be given to the data path in the SIM card 6 via the secure unit 11. The data path is indicated by a path 1 in FIG. 1.

During the authentication of the memory card 9 (the process in Step S101 of FIG. 3), the host unit 8 communicates with the memory card 9 via the secure unit 11 of the SIM card adapter 10 and performs card authentication. In this case, for secure communication, the security register SR of the controller 9b is used.

Subsequently, in the updating of the data in the memory card 9 (the process in Step S103 of FIG. 3), the host unit 8 writes the update data in an arbitrary region of the memory card 9 via the secure unit 11.

On the other hand, the data path when the SIM card 6 and the host unit 8 communicate with each other without interposition of the secure unit 11 therebetween is indicated by a path 2 in FIG. 4.

In this case, in the authentication of the memory card 9 (the process in Step S101 of FIG. 3), the host unit 8 performs direct card authentication with the controller 9b in the memory card 9 via the card interface 8g.

Then, in the updating of the data in the memory card 9 (the process in Step S103 of FIG. 3), the host unit 8 writes the update data directly to the memory card 9 via the card interface 8g.

Next, a description will be given to the data path between the host unit 8 and the base station server 5. The path is indicated by a path 3 in FIG. 4.

In this case, in the server authentication (the process in Step S105 of FIG. 3), the host unit 8 transmits a request for the server authentication from the RF processing unit 7 via the antenna provided in the mobile phone 2. The request is demodulated by the plurality of base stations 3 that have received the request, intensified in the wireless network control apparatus 4, and then sent to the base station server 5.

In the base station server 5, the server control device 5a makes a comparison with the card data corresponding to the device-authentication memory card stored in the hard disk device 5b, thereby performing the card authentication.

In the mirror-updating of the card data (the process in Step S107 of FIG. 3), the host unit 8 divides the card data into packets and sends the packets to the base station server 5 via each of the RF communication unit 7, the base station 3, and the wireless network control apparatus 4, thereby performing the updating of the card data corresponding to the device-authentication memory card.

Next, a description will be given to a process of restoring, when the memory card 9 in use cannot be used any more due to a failure or the like, the data in the memory card 9 in another memory card 9 with reference to the flow chart of FIG. 5.

In this case, the new memory card 9 may be either a blank card or an existing memory card with a different ID.

First, the host unit 8 performs card authentication of the memory card 9 (Step S201). In this case, because the card ID of the memory card that has been used hitherto is stored in the SIM card 6, the memory card ID does not match the card ID of the new memory card 9.

From the mismatch, the host unit 8 recognizes the insertion of the new memory card 9 in the SIM card adapter 10 (Step S202), and performs card authentication of the new memory card 9 (Steps S203 and S204). As a result, the host unit 8 determines that a restoration process (restore) for the new memory card 9 is necessary.

Subsequently, the host unit 8 performs server authentication (Step S205) and establishes secure communication between itself and the base station server 5 when the authentication is successful (Step S206). Thereafter, the host unit 8 outputs a request for restoring to-be-restored data corresponding to the card ID that has been backed up to the base station server 5, and the to-be-restored data is transmitted from the base station server 5 via the secure communication (Step S207).

The host unit 8 concurrently executes a process of writing the transmitted to-be-restored data to the new memory card 9 (Step S208), thereby performing the restoration process.

When the transmission of the to-be-restored data is completed, a normal completion with the base station server 5 is confirmed (Step S209). Subsequently, when the process of writing the to-be-restored data is completed, a normal completion with the memory card 9 is confirmed (Step S210).

In the process of either of Steps S209 and S210, when the normal completion is not recognized, a retry is attempted or an abnormally completed process is determined. In the event of a network error, it is also possible to postpone this process till communication is resumed.

FIG. 6 is an illustrative view showing data communication paths in the wireless communication system 1 in the restoration process of FIG. 5.

First, a description will be given to the data path in the SIM card 6 via the secure unit 11 in the restoration process. The data path is indicated by a path 4 in FIG. 6.

First, in the authentication of the memory card 9 (the process in Step S201 of FIG. 5), the host unit 8 communicates with the memory card 9 through the card interface 8g via the secure unit 11 to perform card authentication. For secure communication, the security register SR of the controller 9b is used herein.

In the process of updating the restored data in the memory card 9 (the process in Step S208 of FIG. 5), the host unit 8 writes the to-be-restored data to the memory 9a through the card interface 8g via the secure unit 11.

On the other hand, the data path when the SIM card 6 and the host unit 8 communicate with each other without interposition of the secure unit 11 therebetween is indicated by a path 5 in FIG. 6.

In this case, in the authentication of the memory card 9 (the process in Step S201 of FIG. 5), the host unit 8 performs card authentication with the controller 9b of the memory card 9 through the card interface 8g (a USB interface or a memory card interface).

In the process of updating the restored data in the memory card 9 (the process in Step S208 of FIG. 5), the host unit 8 writes the update data to the memory card 9 through the card interface 8g.

Next, a description will be given to the data path between the host unit 8 and the base station server 5. The path is indicated by a path 6 in FIG. 6.

In this case, in server authentication (the process in Step S205 of FIG. 5), the host unit 8 transmits a request for the server authentication from the RF processing unit 7 via the antenna provided in the mobile phone 2. The request is demodulated by the plurality of base stations 3 that have received the request, intensified by the wireless network control apparatus 4, and then sent to the base station server 5.

The server control device 5a makes a comparison with the card data corresponding to the device-authentication memory card stored in the hard disk device, thereby performing the card authentication.

In transmitting the encrypted to-be-restored data (the process in Step S207 of FIG. 5), the base station server 5 divides the to-be-restored data into packets and sends the packets to the RF communication unit 7 via the wireless network control apparatus 4 and the base station 3, thereby performing the restoration of the data corresponding to the memory card 9.

FIG. 7 is an illustrative view showing an example when new data overwritten in the memory card 9 is stored in the hard disk device 5b of the base station server 5.

In FIG. 7, the right-hand side shows the storage regions of the memory cards 9 and the left-hand side shows the storage region of the hard disk device 5b.

In the hard disk device 5b, the storage regions corresponding to the individual memory cards 9 are allocated thereto on a one-to-one basis. For example, when overwriting of a file A is performed in the storage region of one of the memory cards 9, data of the same content as that of the latest or newest file A is written as the latest file A0 in the allocated storage region of the hard disk drive 5b.

This enables complete backup of the data in the memory card 9. Although the description has been given to the case where the file is only one in FIG. 7, the same process is performed even when a plurality of files are stored in the memory card 9.

Further, it is also possible for the base station server 5 to perform history management of the file stored in the memory card 9. FIG. 8 is an illustrative view showing an example of history management of up to n (an arbitrary integer from 0) files in the base station server 5.

In the case of performing history management of up to n files, when the overwriting of the file A in the memory card 9 is performed, the latest file A is written as the latest file A0 in the hard disk device 5b of the base station server 5.

The file A0 on the history management file, which has been the latest before the writing, is changed to a file A1 so that the file A1, a file A2, a file An−1 are successively changed to the file A2, a file A3, and a file An, respectively. The oldest file An that has been present before the latest file A1 is written is discarded.

This allows complete backup of the file A in the memory card 9 and allows n-times history management in the base station server 5. Therefore, by referencing the history management file, it is possible to freely return the current latest file to an older file Ak corresponding to an arbitrary history k not more than a history n. Although the description has been given also to the history management of a single file, it is assumed that the same file management is performed also with respect to a plurality of files stored in the memory card 9.

Even when the memory card 9 is destroyed by physical destruction or the like, the present first embodiment can prevent the loss of the data stored in the memory card 9 and significantly improve the reliability of the SIM card 6.

### Embodiment 2

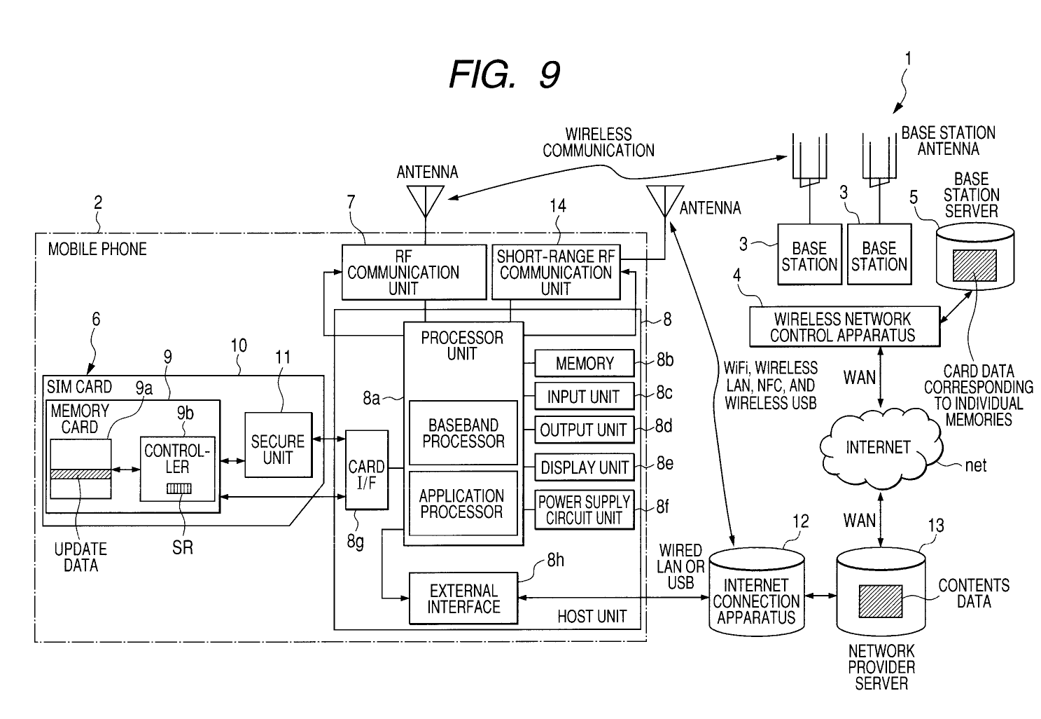

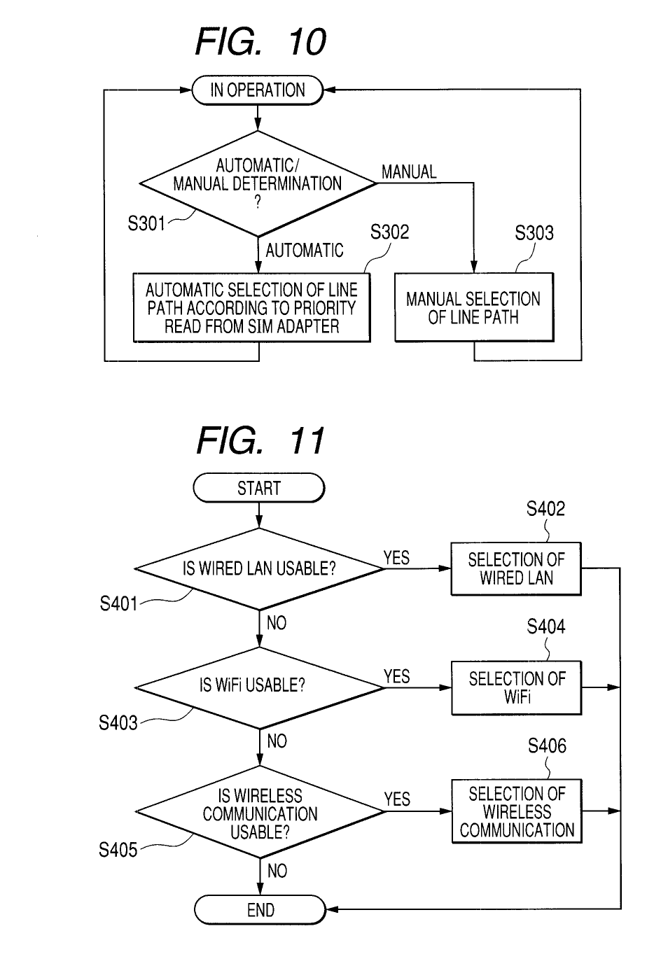

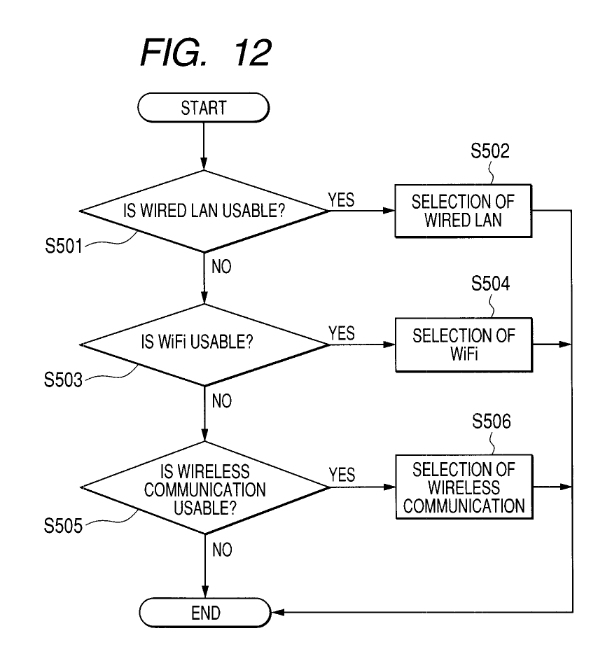

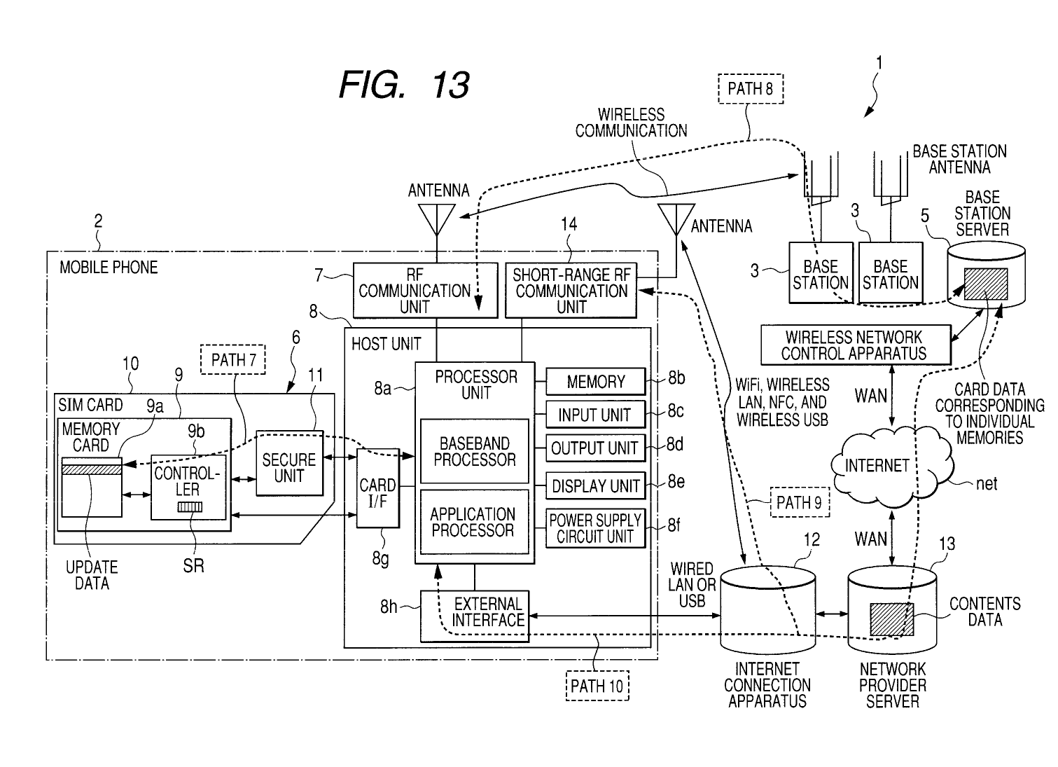

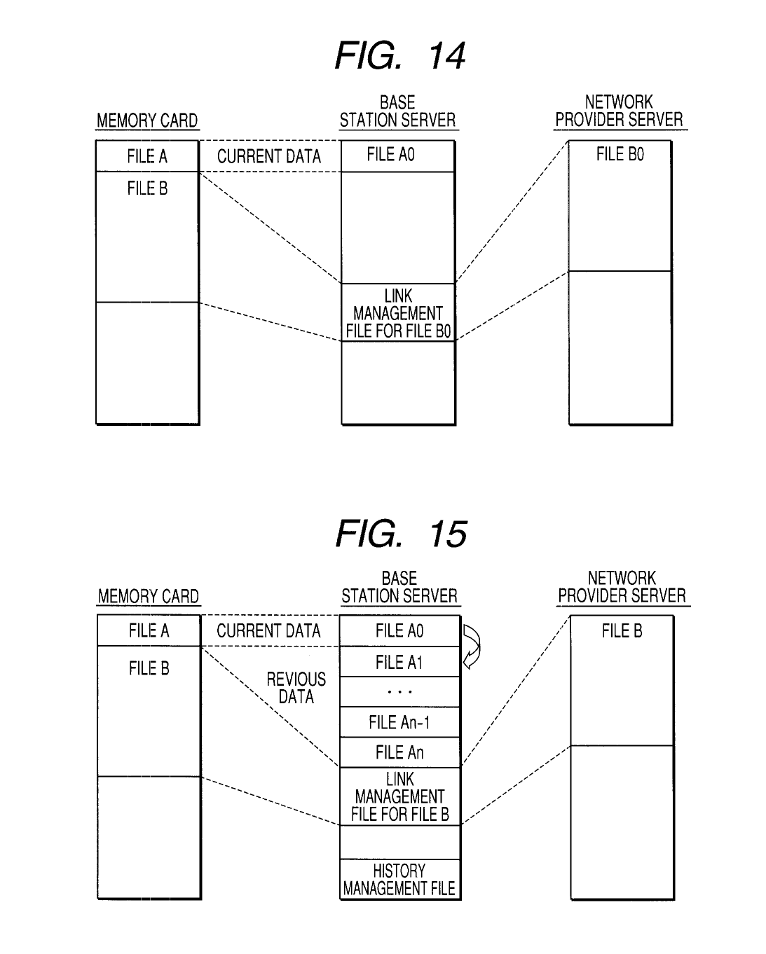

FIG. 9 is an illustrative view showing an example of a structure in a wireless communication system according to the second embodiment of the present invention. FIG. 10 is a flow chart showing an example of a switching process among communication line paths performed by a mobile phone provided in the wireless communication system of FIG. 9. FIG. 11 is a flow chart showing an example of a detailed process in Step S302 of FIG. 10. FIG. 12 is a flow chart showing another example of the detailed process in Step S302 of FIG. 10. FIG. 13 is an illustrative view showing data communication paths in the wireless communication system of FIG. 9. FIG. 14 is an illustrative view showing an example of data backup in the wireless communication system of FIG. 9. FIG. 15 is an illustrative view showing an example of file history management at a base station server in the wireless communication system of FIG. 9.

In the present second embodiment, the wireless communication system has a structure obtained by adding an Internet connection apparatus 12 and a network provider server 13 to the same structure as used in the first embodiment described above which includes the mobile phone 2, the base station 3, the wireless network control apparatus 4, and the base station server 5, as shown in FIG. 9.

The Internet connection apparatus 12 includes, e.g., a personal computer and a set-top box and performs connection to the Internet via the network provider server 13.

The network provider server 13 provides various data, such as music data and image data, and services. The network provider server 13 and the wireless network control apparatus 4 are connected to an Internet line net via, e.g., the WAN (Wide Area Network) or the like.

The mobile phone 2 comprises the SIM card 6, the RF communication unit 7, and the host unit 8 in the same manner as in the first embodiment described above. The mobile phone 2 according to the second embodiment is different from the mobile phone 2 according to the first embodiment described above in that a short-range RF communication unit 14 and an external interface 8b are newly provided.

The short-range RF communication unit 14 performs wireless communication with the Internet connection apparatus 12 using WiFi (Wireless Fidelity), wireless LAN (Local Area Network), NFC (Near Field Communication), wireless USB, or the like.

The external interface 8b is provided in the host unit 8 and serves as an interface (Ethernet (registered trademark), USB, or the like) between the processor unit 8a and the Internet connection apparatus 12.

In this case, the mobile phone 2 can be switched to another communication line path such as a wired LAN or the wireless LAN other than wireless communication using the mobile phone 2.

The mobile phone 2 may also be wiredly or wirelessly connected using a mobile phone cradle or the like to perform the communication mentioned above. With the cradle, it is also possible to perform a process when the mobile phone 2 is in a state supplied from an external power supply.

FIG. 10 is a flow chart showing an example of the switching process among the communication line paths performed by the mobile phone 2.

First, the processor unit 8a determines whether the switching among the communication line paths is to be performed automatically or manually (Step S301). The determination is made based on set data (automatic or manual) preset by the user. The set data includes, e.g., the selection of either automatic switching among the communication line paths or manual switching among the communication line paths, and communication-line-path priority data for setting priorities to the communication line paths in performing automatic switching among the communication line paths.

The communication-line-path priority data includes, e.g., speed priority data for determining the priorities of the communication line paths by giving preference to a communication speed, cost priority data for determining the priorities of the communication line paths by giving preference to communication cost over the communication speed, and the like.

When the processor unit 8a determines automatic setting, the processor unit 8a reads the communication-line-path priority data stored in, e.g., the memory 8b and selects the communication line path in accordance with the priorities set in the communication-line-path priority data (Step S302). On the other hand, when the processor unit 8a determines manual setting, the communication line path is set by, e.g., the user (Step S303).

FIG. 11 is a flow chart showing an example of a detailed process in Step S302 of FIG. 10. FIG. 11 illustrates a process of determining the communication line path when the speed priority data is set. It is assumed herein that, e.g., the wired LAN has the highest line speed, the WiFi has the second highest line speed, and the wireless communication using the mobile phone 2 has the lowest line speed.

First, the processor unit 8a determines whether or not the wired LAN having the highest line speed is usable (Step S401). When the wired LAN is usable, the processor unit 8a selects the line path such that communication is performed using the wired LAN (Step S402).

In the process of S401, when the wired LAN is not usable, the processor unit 8a determines whether or not the WiFi having the second highest line speed next to the wired LAN is usable (Step S403). When the WiFi is usable, the processor unit 8a selects the line path such that communication is performed using the WiFi (Step S404).

In the process of S403, when the WiFi is not usable, the processor unit 8a determines whether or not the wireless communication using the mobile phone 2 having the lowest line speed is usable (Step S405). When the wireless communication using the mobile phone 2 is usable, the processor unit 8a selects the line path such that communication is performed using the wireless communication using the mobile phone 2 (Step S406). In the process of Step S405, when even the wireless communication using the mobile phone 2 is not usable, the process is ended.

FIG. 12 is a flow chart showing an example of the detailed process in Step S302 of FIG. 10. The drawing illustrates a process of determining the communication line path when the cost priority data is set. It is assumed herein that the wired LAN, the WiFi, and the mobile phone 2 have progressively lower wireless communication costs in this order.

First, the processor unit 8a determines whether or not the wired LAN having the lowest communication cost is usable (Step S501). When the wired LAN is usable, the processor unit 8a selects the line path such that communication is performed using the wired LAN (Step S502).

In the process of S501, when the wired LAN is not usable, the processor unit 8a determines whether or not the WiFi having the second lowest communication cost next to the wired LAN is usable (Step S503). When the WiFi is usable, the processor unit 8a selects the line path such that communication is performed using the WiFi (Step S504).

Further, in the process of S503, when the WiFi is not usable, the processor unit 8a determines whether or not the wireless communication using the mobile phone 2 having the highest communication cost is usable (Step S505). When the wireless communication using the mobile phone 2 is usable, the processor unit 8a selects the line path such that communication is performed using the wireless communication using the mobile phone 2 (Step S506). In the process of Step S505, when even the wireless communication using the mobile phone 2 is not usable, the process is ended.

Although the communication speed and lower communication cost have thus been shown as conditions so far, the determination may also be made based on another condition such as communication accuracy.

FIG. 13 is an illustrative view showing the data communication paths in the wireless communication system 1 according to the present second embodiment.

In FIG. 13, the data path in the SIM card 6 via the secure unit 11 is shown as a path 7, the data path between the host unit 8 and the base station server 5 is shown as a path 8, the path between the host unit 8 and the base station server 5 via WiFi, wireless LAN, NFC, wireless USB, or the like is shown as a path 9, and the data path between the host unit 8 and the base station server 5 via wired LAN or USB is shown as a path 10.

In this case, the path 7 is the same as the path 1 (FIG. 4) in the first embodiment described above, and the path 8 is the same as the path 3 (FIG. 4) in the first embodiment described above.

In the path 9, wireless communication from the base station server 5 is performed between the Internet connection apparatus 12 and the short-range RF communication unit 14 via the Internet line net and the network provider server 13 so that an access is made to the host unit 8 via the path.

In the path 10, wired communication from the base station server 5 is performed between the Internet connection apparatus 12 and the external interface 8h via the Internet line net and the network provider server 13 so that an access is made to the host unit 8 via the path 10.

The wireless communication system 1 according to the present second embodiment may also be such that, e.g., only important data including registered information such as an IMSI number and a mobile phone number, phone directory data, and the like is backed up in the base station server 5, while various multimedia contents such as music data and video data are backed up in the network provider server 13.

FIG. 14 is an illustrative view showing an example in which, of new data overwritten in the memory card 9, the important data is backed up in the base station server 5 and the data including the multimedia contents and the like is backed up in the network provider server 13.

In FIG. 14, the storage region of the memory card 9, the storage region of the hard disk device 5b of the base station server 5, and the storage region of the network provider server 13 are shown in this order in the left-to-right direction.

In the memory card 9, the important data including the registered data such as the IMSI number and the mobile phone number, the phone directory data, and the like is stored in a file A, while the other various data including the multimedia contents and the like is stored in a file B.

The same data as that in the file A of the memory card 9 is stored in a file A0 in the hard disk device 5b, while the data in the file B is stored in a file B0 in the network provider server 13.

The hard disk device 5b also has a link management file showing a destination to which the file B0 is linked. The base station server 5 manages the file B0 stored in the network provider server 13 in accordance with the link management file.

FIG. 15 is an illustrative view showing an example of history management of up to n (an arbitrary integer from 0) files at the base station server 5. In this case, the history management is performed by the same process as shown in FIG. 8 according to the first embodiment described above.

Likewise, it is also possible to perform history management of the file B comprised of the data including the multimedia contents and the like. At that time, the same history management process as shown in FIG. 8 may also be performed by the network provider server 13.

As a result, the present second embodiment can support not only the wireless communication using the mobile phone 2 but also the plurality of communication paths including the wired LAN, the wireless LAN, and the like. This allows improvements in data communication speed and communication quality as well as performance enhancement.

By connecting to the network provider server 13, it is possible to provide data (e.g., music data, video data, services, and the like) from the network provider server 13 other than the base station server 5 to the mobile phone 2.

By further supporting the wired LAN and the Internet line net, a process of synchronizing the memory card 9 with the base station server 5 can be performed at a high speed in the Internet connection apparatus 12.

### Embodiment 3

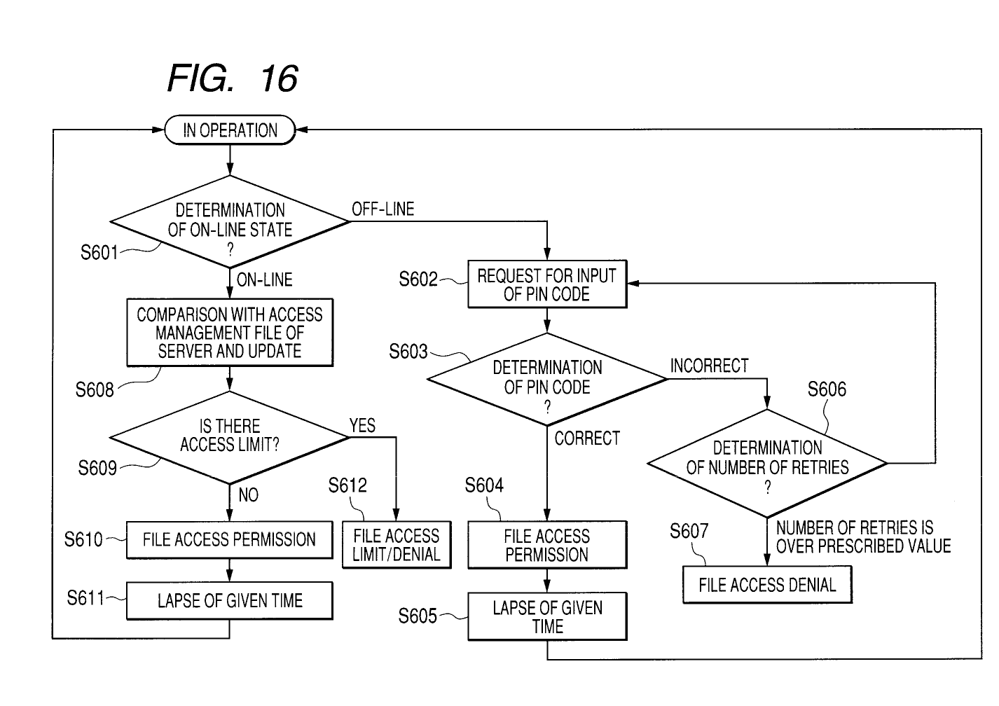

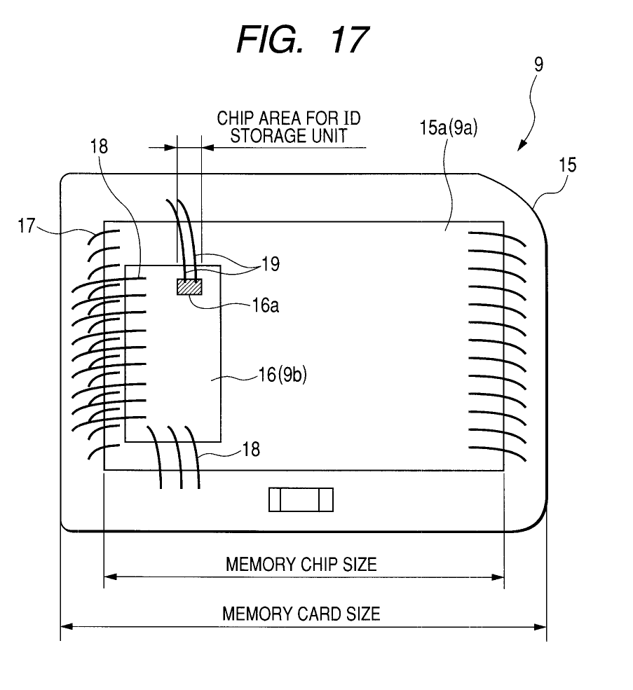

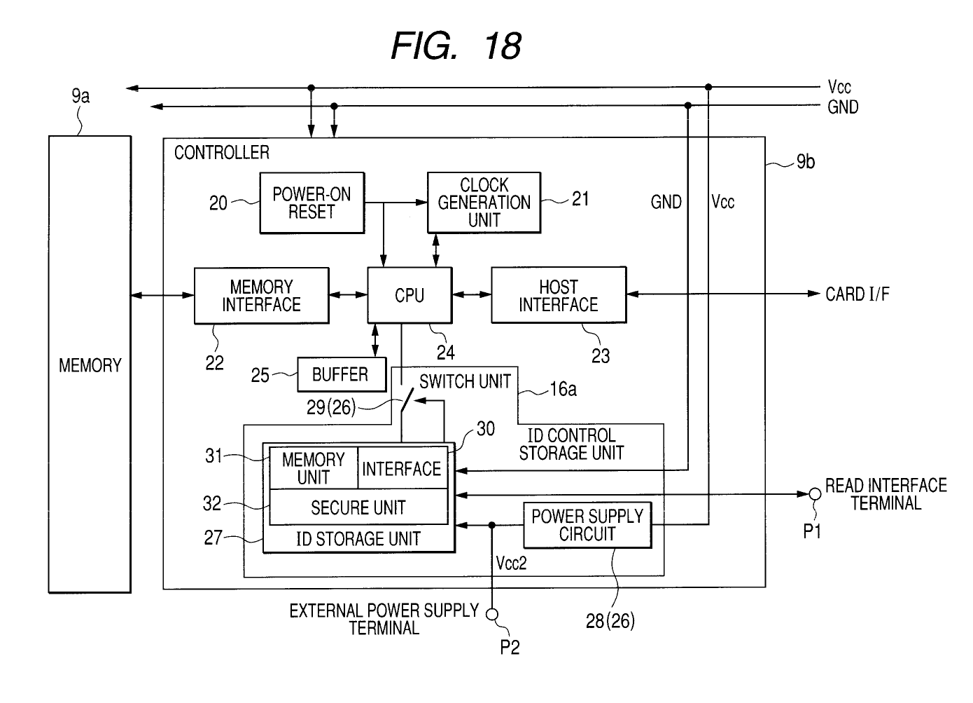

FIG. 16 is a flow chart showing an example of a process when an access to a memory card is limited according to the third embodiment of the present invention. FIG. 17 is an illustrative view showing an example of a chip layout of the memory card according to the third embodiment. FIG. 18 is a block diagram showing an example of a structure of the controller of FIG. 17.

In the present third embodiment, a description will be given to a technology for disabling the use of data in the memory card 9 in the structure of the wireless communication system 1 (FIG. 9) according to the second embodiment described above.

For example, to disable the use of the data in the memory card 9 in the event of the loss of the mobile phone 2 or the like, an access is made to the base station server 5 from another phone, a personal computer, an Internet terminal, or the like to change an access management file corresponding to each of the SIM cards 6 and set an access denial or an access limit to the memory card 9 or the secure unit 11.

The access denial/access limit implements rapid lock/unlock operations by changing the management file from an accessible path among a plurality of paths (wireless communication using the mobile phone, WiFi, wireless LAN, NFC, wireless USB, wired LAN, USB, and the like).

The access management file of the SIM card 6 is managed at the base station server 5 in correspondence to the access management file thereof. An unlock method is implemented by setting an access permission by updating the access management file in the same manner as in a lock method.

For example, when an access permission to the access management file is switched to an access denial, the unlock operation becomes impossible.

FIG. 16 is a flow chart showing an example of a process when an access limit to the memory card 9 is set from another phone, a personal computer, an Internet terminal, or the like.

First, the processor unit 8a determines whether or not the communication line of the mobile phone 2 is on-line or off-line (Step S601). When the communication line is off-line, the processor unit 8a requests an input of a PIN (Personal Identity Number) code upon the activation of the mobile phone 2 (Step S602) to check security during an off-line period.

When the PIN code is inputted in response to the input request for the PIN code, the processor unit 8a determines whether or not the inputted PIN code is correct (Step S603). When the inputted PIN code is correct, the processor unit 8a permits a file access (Step S604) in accordance with the access management file stored in the SIM card 6. Thereafter, when an arbitrary set time elapses (Step S605), the processor unit 8a returns again to the process of Step S601.

When the inputted PIN code is not correct in the process of Step S603, the processor unit 8a determines the number of retries (the number of times the PIN code is inputted) (Step S606). When the number of retries is not more than a prescribed value, the processor unit 8a returns again to the process of Step S602.

In the process of Step S605, when it is determined that the number of retries is over the prescribed value, the processor unit 8a denies the file access to the memory card 9 (S607).

On the other hand, when it is determined that the communication line is on-line in the process of Step S601, the processor unit 8a makes a comparison between the access management file of the base station server 5 and that of the SIM card 6 and performs an update process with respect to the content of the latest access management file when the access management files are different (Step S607).

Subsequently, the processor unit 8a determines whether or not the access limit is set to the access management file (Step S609). When the access limit is not set to the access management file, the processor unit 8a does not limit the file access (Step S610).

Thereafter, when an arbitrary set time elapses (Step S611), the processor unit 8a returns again to the process of Step S601. The process continuing from Step S601 is performed not only by the process in Step S611 or S605 but also when there is an urgent interrupt request from the carrier side. The urgent interrupt request is issued when an immediate access limit is intended to be set due to the loss of the mobile phone 2 or the like.

On the other hand, when an access limit is set to the access management file in the process of Step S609, the processor unit 8a sets the file access limit to the memory card 9 (Step S612).

Next, a description will be given to a technology for restoring data using a unique ID number imparted to the memory card 9.

When data in the memory card 9 is lost due to the physical destruction thereof and the lost data is to be restored, it is considered to use the unique ID number imparted to the memory card 9 to ensure security in a data restoring procedure performed by specifying and authenticating the data.

FIG. 17 is an illustrative view showing an example of a chip layout of the memory card 9.

As shown in the drawing, the memory card 9 has a semiconductor chip 15a serving as the memory 9a mounted on the principal surface of a card wiring board 15. On the upper portion of the semiconductor chip 15a, a semiconductor chip 16 serving as the controller 9b is stacked.

A plurality of bonding electrodes are formed on the portions of the chip mounting surface of the card wiring board 15 which are adjacent to the peripheral portions of the two opposing edges of the semiconductor chip 15a. On the peripheral portions of the two opposing edges of the semiconductor chip 15a, a plurality of chip electrodes are provided. The chip electrodes and board electrodes are connected to each other via bonding wires 17.

In addition, a plurality of bonding electrodes are also formed on the portions of the chip mounting surface of the card wiring board 15 which are adjacent to the peripheral portions of the two adjacent edges of the semiconductor chip 16. The bonding electrodes and a plurality of chip electrodes formed on the peripheral portions of the two adjacent edges of the semiconductor chip 16 are connected to each other via bonding wires 18.

Layout on the upper portion of the semiconductor chip 16 of FIG. 17 is such that an ID control storage unit 16a is formed thereon. The ID control storage unit 16a is provided with a read interface terminal P1 (FIG. 18) and with an external power supply terminal P2 (FIG. 18).

The ID control storage unit 16a is connected from the read interface terminal P1 and the external power supply terminal P2 to the board electrodes of the card wiring board 15 via respective bonding wires 19 so as to be capable of direct communication with the secure unit 11 without interposition of the controller 9b therebetween.

The ID control storage unit 16a stores the ID number of the memory card 9. The ID control storage unit 16a is used for authentication when data is backed up or restored in the base station server 5. Because the ID number is small-capacity (on the order of several bytes to several tens of bytes) data, the area occupied by the ID control storage unit 16a on the semiconductor chip 16 is small. Accordingly, even when a mechanical stress such as bending or distortion is applied to the memory card 9, the possibility of destruction can be minimized irrespective of the presence or absence of communication.

FIG. 18 is a block diagram showing an example of s structure of the controller 9b provided with the ID control storage unit 16a.

The controller 9b comprises a power-on reset 20, a clock generation unit 21, a memory interface 22, a host interface 23, a CPU 24, a buffer 25, and the ID control storage unit 16a.

The power-on reset 20 manages control operations of a power supply system, such as a reset process for the controller 9b. The clock generation unit 21 generates a clock signal and supplies the generated clock signal to the CPU 24 and the like. The memory interface 22 is an interface with the memory 9a. The host interface 23 is an interface with the host unit 8.

The CPU 24 manages all the control operations of the controller 9b. The buffer 25 temporarily stores to-be-transferred data during data transfer or the like. The ID control storage unit 16a operates solely when the controller 9b becomes faulty due to destruction or the like, and allows reading of the ID number of the memory card 9 and the like.

The ID control storage unit 16a comprises a power supply switching circuit 26 and an ID storage unit 27. The power supply switching circuit 26 includes a power supply circuit 28 and a switch unit 29. The ID storage unit 27 comprises an interface 30, a memory unit 31, and a secure unit 32.

The power supply circuit 28 monitors a power supply voltage VCC supplied to the controller 9b and outputs a control signal for switching to the switch unit 29 and decouples a wiring line for a power supply voltage VCC when the power supply voltage VCC is no more supplied due to a short circuit resulting from the failure or destruction of the controller 9b.

To the ID storage unit 27, the external power supply terminal P2 is coupled. When the power supply circuit 28 decouples the wiring line for the power supply voltage VCC, a power supply voltage VCC2 is externally supplied via the external power supply terminal P2 to bring the ID storage unit 27 into a solely operative state.

The switch unit 29 has one coupling portion coupled to the CPU 24 and the other coupling portion coupled to the interface 30. The switch unit 29 receives the control signal for switching outputted from the power supply circuit 28 and brings the CPU 24 and the interface 30 into a decoupled state.

The interface 30 is an interface with the CPU 24. The interface 30 is coupled to the read interface terminal P1 used when the ID number is read from the outside.

Examples of reading via the read interface terminal P1 includes 1-bit serial communication. This allows a reduction in the number of external terminals and a reduction in coupling failures or the like. Alternatively, non-contact communication or the like may also be used.

In the memory unit 31, the ID number of the memory card 9 is stored. The secure unit 32 is a secure section for performing authentication and encryption when the ID number is read via the interface 30.

By thus providing the ID control storage unit 16a which operates independently of the controller 9b, it is possible to improve the possibility of allowing the ID number of the memory card 9 for data restoration to be read even when the controller 9b becomes faulty.

As a result, it is possible in the present third embodiment to set an immediate access limit to the memory card 9 from another phone, a personal computer, an Internet terminal, or the like. This allows more reliable data protection for the memory card 9.

Since the ID number of the memory card 9 can be read with a higher probability, a restoring operation such as data restoration can be performed more efficiently.

Although the invention achieved by the present inventors has thus been described specifically based on the embodiments thereof, the present invention is not limited thereto. It will be easily appreciated that various modifications can be made in the invention without departing from the gist thereof.

For example, the wireless communication system according to the present invention may also be constructed by combining at least two of the first to third embodiments described above or by combining parts of the individual embodiments.

The present invention is suited to a technology for preventing the loss of data stored in a secure memory card, such as a SIM card, due to the physical destruction thereof.

What is claimed is:

1. A wireless communication system comprising:
a mobile communication terminal including: a SIM card in which data including data for determining whether or not wireless communication is usable is stored; an RF communication unit for performing high-frequency power amplification to output a high-frequency signal for performing the wireless communication as well as processing of a signal received by the wireless communication; and a host unit for managing control of the SIM card and the RF communication unit;
a plurality of base stations each for receiving an electric wave from the mobile terminal or transmitting the electric wave to the mobile communication terminal, and securing a wireless communication line between itself and the mobile communication terminal with which the base station is in communication;
a wireless network control unit for intensifying the electric waves transmitted/received by the base stations to perform integrated control; and
a base station server for executing mirror-updating and restoration of the data stored in the SIM card in response to a request from the mobile communication terminal,
wherein the base station server has a data storage unit to which the data stored in the individual SIM card is mirror-updated, and mirror-updates the data in the SIM card to the data storage unit when data is newly stored in the SIM card or the data in the SIM card is updated.

2. A wireless communication system according to claim 1, wherein the data stored in the SIM card includes user data stored in the SIM card individually by a user of the mobile communication terminal.

3. A wireless communication system according to claim 1, wherein the SIM card includes: a memory card for storing the data stored in the SIM card; and a SIM card adapter in which a secure unit for performing secure communication is provided and to which the memory card is attached.

4. A wireless communication system according to claim 3,
wherein the memory card comprises: a nonvolatile semiconductor memory for storing the data; and a controller for controlling an operation of the nonvolatile semiconductor memory, and
wherein the controller comprises an ID control storage unit which is coupled to each of an external power supply terminal supplied with an external power supply voltage and a read interface terminal used when an ID number is read from an outside and which individually operates independently of the controller with a supply of the power supply voltage via the external power supply terminal when the controller becomes inoperative, to allow the ID number of the memory card to be read via the read interface terminal.

5. A wireless communication system according to claim 4, wherein the ID control storage unit comprises: a power supply circuit for monitoring the power supply voltage supplied to the controller, and decoupling a wiring line for the power supply voltage when the power supply voltage is not supplied any more; an ID storage unit for storing the ID number of the memory card; and a secure unit for performing secure communication when the ID number stored in the ID storage unit is read therefrom.

6. A wireless communication system according to claim 1,
wherein the host unit issues, when data is stored in the SIM card, an update request for requesting mirror-updating of the data to the base station server, and transmits the data to be mirror-updated to the base station server, and
wherein the base station server mirror-updates the data transmitted from the host unit to the data storage unit when there is the request from the host unit.

7. A wireless communication system according to claim 2,
wherein the host unit determines that a restoration process for the memory card is necessary when a new card is attached, issues a restoration request for requesting restoration of the data in the memory card that has been used hitherto to the base station server, and stores the mirror-updated data transmitted from the base station server in the new memory card, and
wherein the base station server transmits the mirror-updated data of the corresponding memory card stored in the data storage unit to the host unit when there is the request from the host unit.

8. A wireless communication system according to claim 2, wherein the base station server mirror-updates, every time file data in the memory card is overwritten, the overwritten latest file data to the data storage unit.

9. A wireless communication system according to claim 2, wherein the base station server updates, every time file data in the memory card is overwritten, a history management file for managing a history of a file data update and mirror-updates, to the data storage unit, the file data in a latest file and in an arbitrary number of files previous to the latest file.

10. A wireless communication system according to claim 1, further comprising:
a network provider server for providing various data such as music data and image data, a service, and the like; and
an Internet connection apparatus connected to the network provider server to achieve a connection to the Internet via an Internet line,
wherein the mobile communication terminal comprises: a short-range RF communication unit for performing wireless communication with the Internet connection apparatus; and an external interface for performing wired communication with the Internet connection apparatus, and
wherein the host unit selects a communication path with the base station server from among the wireless communication performed by the RF communication unit, the wireless communication performed by the short-range RF communication unit, and the wired communication performed by the external interface, in performing the mirror-updating of the data or the restoration of the data.

11. A wireless communication system according to claim 10,
wherein the short-range RF communication unit performs the wireless communication with the Internet connection apparatus using wireless LAN, NFC, wireless USB, or the like, and
wherein the external interface performs the wired communication using Ethernet, USB, or the like.

12. A wireless communication system according to claim 9, wherein the host unit retrieves usable communication line paths from among communication line paths provided by the RF communication unit, the short-range RF communication unit, or the external interface, and preferentially uses the communication line path satisfying a preset condition among the retrieved usable communication line paths.

13. A wireless communication system according to claim 10, wherein the base station server stores only the important data among the mirror-updated data of the SIM card in the data storage unit and stores the other data thereamong in the network provider server.

14. A wireless communication system according to claim 10, wherein the host unit retrieves set data to which an access limit is set and which is stored in the data storage unit when there is a request for an access limit to the SIM card via the wireless communication line, and implements the access limit to the SIM card based on the set data.

15. A SIM card comprising:
a memory card comprising a nonvolatile semiconductor memory for storing data and a controller for controlling an operation of the nonvolatile semiconductor memory; and
a SIM card adapter in which a secure unit for performing secure communication is provided and to which the memory card is attached,
wherein the controller comprises an ID control storage unit which is coupled to each of an external power supply terminal supplied with an external power supply voltage and a read interface terminal used when an ID number is read from an outside and which individually operates independently of the controller with a supply of the power supply voltage via the external power supply terminal when the controller becomes inoperative, to allow the ID number of the memory card to be read via the read interface terminal.

16. A SIM card according to claim 15, wherein the ID control storage unit comprises: a power supply circuit for monitoring the power supply voltage supplied to the controller, and decoupling a wiring line for the power supply voltage when the power supply voltage is not supplied any more; an ID storage unit for storing the ID number of the memory card; and the secure unit for performing secure communication when the ID number stored in the ID storage unit is read therefrom.

17. A mobile communication terminal comprising:
a SIM card in which data including data for determining whether or not wireless communication is usable is stored;
an RF communication unit for performing high-frequency power amplification to output a high-frequency signal for performing the wireless communication as well as processing of a signal received by the wireless communication; and
a host unit for controlling the SIM card and the RF communication unit,
wherein the host unit issues, when data is stored in the SIM card, an update request for requesting mirror-updating of the data to a base station server connected via the wireless communication, and transmits the data to be mirror-updated to the base station server to allow the base station server to mirror-update the data in the SIM card.

18. A mobile communication terminal according to claim 17, wherein the host unit determines that a restoration process for the memory card is necessary when a new memory card is attached, issues a restoration request for requesting restoration of the data in the memory card that has been used hitherto to the base station server, and stores the mirror-updated data transmitted from the base station server in the new memory card.

19. A mobile communication terminal according to claim 17, wherein the data stored in the SIM card includes user data stored individually by a user of the mobile communication terminal in the SIM card.

20. A mobile communication terminal according to claim 17, further comprising:
a short-range RF communication unit for performing wireless communication with an Internet connection apparatus connected to a network provider server to achieve a connection to the Internet via an Internet line; and
an external interface for performing wired communication with the Internet connection apparatus,
wherein the host unit selects a communication path with the base station server from among the wireless communication performed by the RF communication unit, the wireless communication performed by the short-range RF communication unit, and the wired communication performed by the external interface, in performing the mirror-updating of the data or the restoration of the data.

21. A mobile communication terminal according to claim 20,
wherein the short-range RF communication unit achieves the connection to the Internet using wireless LAN, NFC, wireless USB, or the like, and
wherein the external interface achieves the connection to the Internet using Ethernet, USB, or the like.

22. A mobile communication terminal according to claim 20, wherein the host unit retrieves usable communication line paths from among communication line paths provided by the RF communication unit, the short-range RF communication unit, or the external interface, and preferentially uses the preset communication line path which is lowest in communication cost among the retrieved usable communication line paths.

23. A mobile communication terminal according to claim 20, wherein the host unit retrieves usable communication line paths from among communication line paths provided by the RF communication unit, the short-range RF communication unit, or the external interface, and preferentially uses the preset communication line path which is highest in communication speed among the retrieved usable communication line paths.

24. A mobile communication terminal according to claim 17, wherein the host unit retrieves set data to which an access limit is set and which is stored in the data storage unit when there is a request for an access limit to the SIM card, and implements the access limit to the SIM card based on the set data.

25. A method of guaranteeing data using a wireless communication system comprising:
a mobile communication terminal including: a SIM card in which data including data for determining whether or not wireless communication is usable is stored; an RF communication unit for performing high-frequency power amplification to output a high-frequency signal for performing the wireless communication as well as processing of a signal received by the wireless communication; and a host unit for controlling the SIM card and the RF communication unit;
a plurality of base stations each for emitting an electric wave from the mobile communication terminal or transmitting the electric wave to the mobile communication terminal, and securing a wireless communication line between itself and the mobile communication terminal with which the base station is in communication;
a wireless network control unit for intensifying the electric waves transmitted/received by the base stations to perform integrated control; and
a base station server for executing mirror-updating and restoration of the data stored in the SIM card in response to a request from the mobile communication terminal,
the method comprising the steps of:
causing the host unit to perform wireless communication with the base station server when updating of the data in the SIM card is completed, and issue the request for the mirror-updating of the update data stored in the SIM card; and
causing the base station server to mirror-update, to the data storage unit, the data stored in the SIM card and transmitted from the host unit in response to the request from the host unit, and back up the data stored in the SIM card.

26. A method of guaranteeing data according to claim 25, further comprising the steps of:
causing the host unit to perform card authentication when a memory card to be attached to the SIM card is attached, determine that a restoration process for the memory card is necessary when a result of the card authentication of the memory card is discrepant, and issue a request for transmission of the backed-up data to the base station server;
causing the base station server to transmit to-be-restored data backed up in the data storage unit in response to the request; and
causing the host unit to write, in the memory card, the to-be-restored data transmitted from the base station server.
